(19) United States
(12) Patent Application Publication
(10) Pub. No.: US 2026/0269338 A1
(43) Pub. Date: Sep. 10, 2026

(54) WEIGHING APPARATUS AND WEIGHING METHOD

(71) Applicant: HONDA MOTOR CO., LTD., Tokyo (JP)

(72) Inventors: Takuya KOIZUMI, Saitama (JP); Ryota HIRAZAKURA, Saitama (JP); Takuya SUGURO, Saitama (JP); Shuta SAKAI, Saitama (JP); Makoto TANAKA, Saitama (JP); Yuya HATTORI, Saitama (JP); Keiko MORI, Saitama (JP)

(21) Appl. No.: 19/547,699

(22) Filed: Feb. 24, 2026

(30) Foreign Application Priority Data
Mar. 10, 2025 (JP) 2025-037290

(51) Int. Cl. H01M 10/42

(52) U.S. Cl. CPC H01M 10/4285

(57) ABSTRACT

Provided is a weighing apparatus, a weighing system, and a weighing method capable of suppressing contact between a solid electrolyte and air and suppressing accumulation of the solid electrolyte. A weighing apparatus 10 includes: a first storage-equipped quantitative feeder device 15 including a first storage 152 that stores the solid electrolyte SE, and a first quantitative feeder 154 that quantitatively measures the solid electrolyte SE stored in the first storage 152 and feeds the solid electrolyte SE to a first outlet port 153 provided in a lower side surface; a first pipe 12 that has one end fixed to the first inlet port 151 and another end connectable to an FC 30; a first exhauster 22 that exhausts gas from an inside of the first storage-equipped quantitative feeder device 15; and a first air supplier 21 that supplies gas to the inside of the first storage-equipped quantitative feeder device 15.

### CROSS-REFERENCE TO RELATED APPLICATION

This application is based on and claims the benefit of priority from Japanese Patent Application No. 2025-037290, filed on 10 Mar. 2025, the content of which is incorporated herein by reference.

### BACKGROUND OF THE INVENTION

### Field of the Invention

The present invention relates to a weighing apparatus and a weighing method.

### Related Art

In recent years, research and development of secondary batteries that contribute to energy efficiency has been carried out in order to ensure many people have access to affordable, reliable, sustainable, and advanced energy.

Among the secondary batteries, all-solid-state batteries including a solid electrolyte as an electrolyte are particularly receiving attention because they have an excellent feature of providing high safety due to the non-flammable nature of the solid electrolyte and having higher energy density. Studies are being conducted on an all-solid- state battery that has a laminated structure in which a plurality electrode (positive electrode layers and negative electrode layers) are alternately laminated with solid electrolyte layers interposed therebetween.

The solid electrolyte layers are formed by applying a solid electrolyte slurry to the positive electrode layers, for example. When the solid electrolyte slurry is produced, solid electrolyte powder is weighed (for example, Japanese Unexamined Patent Application, Publication No. 2018-081914).

Patent Document 1: Japanese Unexamined Patent Application, Publication No. 2018-081914

### SUMMARY OF THE INVENTION

In weighing of a solid electrolyte, a case where solid electrolyte powder enclosed in a flexible container is introduced into a quantitative feeder is assumed. It is desirable for the solid electrolyte not to be in contact with air. For this reason, coupling the flexible container to the quantitative feeder with piping and causing the solid electrolyte powder to flow down through the piping is conceivable.

However, since the solid electrolyte powder has a relatively slight tendency to flow, there is a concern that the solid electrolyte powder may not smoothly flow down in the piping.

An object of the present invention is to provide a weighing apparatus and a weighing method that are adapted for a solid electrolyte for an all-solid-state battery and are capable of suppressing contact between the solid electrolyte and air and suppressing accumulation of the solid electrolyte. The present invention thus contributes to an improvement in energy efficiency.

(1) The present invention relates to a weighing apparatus for a solid electrolyte for an all-solid-state battery, the weighing apparatus including: a first storage-equipped quantitative feeder device including a storage that is connected to a solid electrolyte inlet port provided at an upper portion and stores the solid electrolyte, and a quantitative feeder that quantitatively measures the solid electrolyte stored in the storage and feeds the solid electrolyte to a solid electrolyte outlet port provided in a lower side surface; an inlet pipe that has one end fixed to the solid electrolyte inlet port and another end connectable to a solid electrolyte transporting container in which the solid electrolyte is accommodated; an exhauster that exhausts gas from an inside of the first storage-equipped quantitative feeder device; and an air supplier that supplies gas to the inside of the first storage-equipped quantitative feeder device.

According to the weighing apparatus described in (1), the solid electrolyte transporting container and the first storage-equipped quantitative feeder device are connected by the inlet pipe, and it is thus possible to suppress contact of the solid electrolyte with air at the time of weighing.

Since the solid electrolyte has relatively poor flowability, there is a concern that the solid electrolyte may be accumulated in the inlet pipe, for example. However, according to the weighing apparatus described in (1), it is possible to suppress accumulation of the solid electrolyte by controlling an inner pressure of the weighing apparatus and causing the pressure to act on the solid electrolyte.

Therefore, it is possible to provide a weighing apparatus capable of suppressing contact between the solid electrolyte and air and suppressing accumulation of the solid electrolyte.

(2) In the weighing apparatus described in (1) above, the solid electrolyte inlet port is disposed in an upper surface of the first storage-equipped quantitative feeder device.

According to the weighing apparatus described in (2), it is possible to suppress degradation of quality of the solid electrolyte accommodated in the storage, for example.

(3) The weighing apparatus described in (1) or (2) above further includes: a glove box that accommodates the solid electrolyte transporting container.

According to the weighing apparatus described in (3), it is possible to suppress contact of the solid electrolyte with air when the solid electrolyte inside the solid electrolyte transporting container is loaded into the weighing apparatus.

Also, if the solid electrolyte transporting container is disposed in the glove box, there is a concern that the solid electrolyte transporting container may contract due to influences of the pressure of gas with a progress of the loading of the solid electrolyte. If the solid electrolyte transporting container is brought into a contracting state, a state where it is difficult for the solid electrolyte to flow down in the solid electrolyte transporting container results, and there is a concern that it may become difficult for the solid electrolyte to flow down smoothly from the solid electrolyte transporting container to the solid electrolyte inlet port. However, according to the weighing apparatus described in (3), it is possible to suppress accumulation of the solid electrolyte by controlling the inner pressure of the weighing apparatus and causing the pressure to act on the solid electrolyte.

In the weighing apparatus described in any one of (1) to (3) above, the first storage-equipped quantitative feeder device is disposed in a space in which a dew point is managed.

According to the weighing apparatus described in (4), it is possible to suppress degradation of quality of the solid electrolyte accommodated in the storage, for example.

(5) In the weighing apparatus described in any one of (1) to (4) above, the solid electrolyte is a sulfide solid electrolyte.

The sulfide-based solid electrolyte particularly requires handling in a dry environment among solid electrolytes. According to the weighing apparatus described in (5), it is possible to smoothly weigh the solid electrolyte, which is the sulfide-based solid electrolyte, while suppressing contact thereof with air.

(6) The weighing apparatus described in any one of (1) to (5) above further includes: a controller that controls the exhauster and the air supplier to adjust a pressure inside the first storage-equipped quantitative feeder device.

According to the weighing apparatus described in (6), it is possible to more suitably suppress accumulation of the solid electrolyte.

(7) The weighing apparatus described in (1) to (6) above further includes: a second storage-equipped quantitative feeder device including a storage that is connected to a solid electrolyte inlet port provided at an upper portion and stores the solid electrolyte and a quantitative feeder that quantitatively measures the solid electrolyte stored in the storage and feeds the solid electrolyte to a solid electrolyte outlet port provided in a lower side surface, and the solid electrolyte inlet port of the second storage-equipped quantitative feeder device is connected to the solid electrolyte outlet port of the first storage-equipped quantitative feeder device via a connection pipe.

According to the weighing apparatus described in (7), it is possible to adjust a supply speed of the solid electrolyte to the second storage-equipped quantitative feeder device by the first storage-equipped quantitative feeder device provided between the solid electrolyte transporting container and the second storage-equipped quantitative feeder device.

(8) A weighing method for weighing a solid electrolyte for an all-solid-state battery using the weighing apparatus described in (1) to (7) above, the method including: connecting the solid electrolyte transporting container accommodating the solid electrolyte to the inlet pipe; storing the solid electrolyte accommodated in the solid electrolyte transporting container in the storage of the first storage-equipped quantitative feeder device; and quantitatively measuring the solid electrolyte stored in the storage using the first storage-equipped quantitative feeder and feeding the solid electrolyte to the solid electrolyte outlet port.

According to the weighing method described in (8), it is possible to suppress contact between the solid electrolyte and air until the solid electrolyte inside the solid electrolyte transporting container is stored in the storage and is further weighed. Also, it is possible to suppress accumulation of the solid electrolyte by using the weighing apparatus of the above embodiment.

(9) In the weighing method described in (8) above, the storing includes suctioning the solid electrolyte accommodated in the solid electrolyte transporting container to inside of the weighing apparatus by lowering an inner pressure in the weighing apparatus using the exhauster.

According to the weighing method described in (9), it is possible to cause the solid electrolyte inside the solid electrolyte transporting container to smoothly flow down to the storage with a pressure difference of the gas.

(10) In the weighing method described in (8) or (9) above, the storing includes pushing the solid electrolyte accommodated in the solid electrolyte transporting container out to inside of the weighing apparatus by supplying gas to the solid electrolyte transporting container by way of raising an inner pressure in the weighing apparatus using the air supplier.

According to the weighing method described in (10), it is possible to expand the solid electrolyte transporting container with a pressure of gas, for example, and to thereby achieve a state where it is easy for the solid electrolyte to flow down along the inner surface of the solid electrolyte transporting container. It is thus possible to suitably suppress accumulation of the solid electrolyte.

According to the present invention, it is possible to provide a weighing apparatus and a weighing method for a solid electrolyte for an all-solid-state battery capable of suppressing contact between the solid electrolyte and air and suppressing accumulation of the solid electrolyte.

### BRIEF DESCRIPTION OF THE DRAWINGS

FIG. 1 is a conceptual diagram illustrating a weighing apparatus according to an embodiment; and

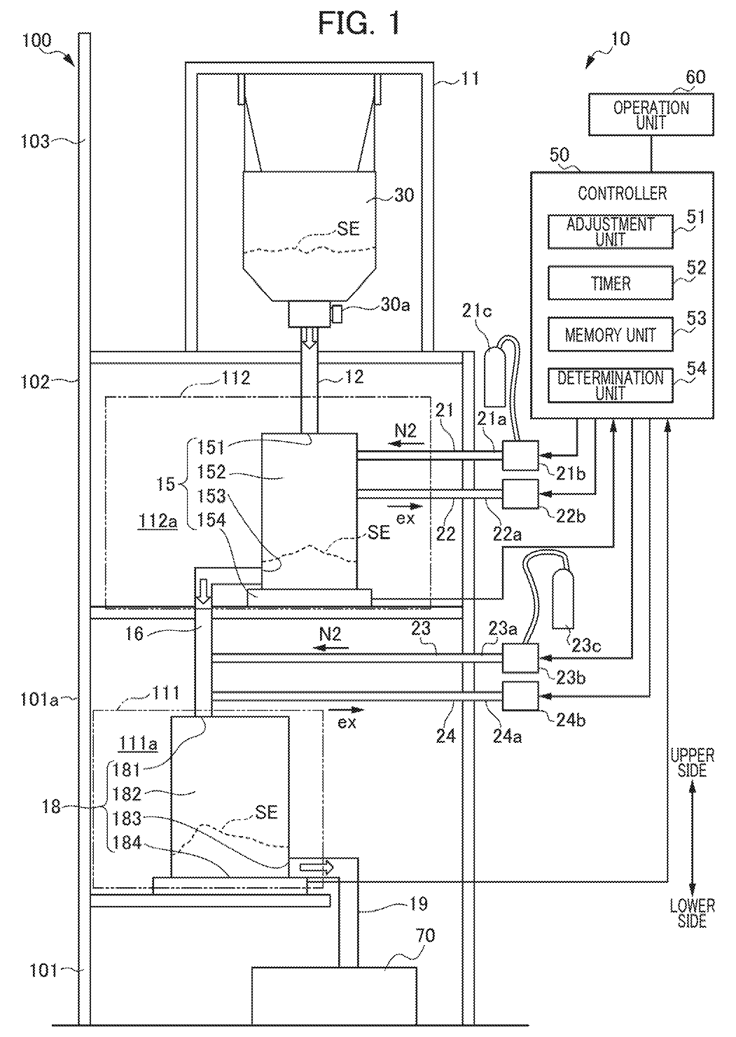

FIG. 2 is a flowchart illustrating a weighing method according to the embodiment.

### DETAILED DESCRIPTION OF THE INVENTION

Hereinafter, a weighing apparatus 10 according to an embodiment of the present invention will be described. The weighing apparatus 10 is used to weigh a solid electrolyte SE for an all-solid-state battery. Note that the solid electrolyte SE is weighed by the weighing apparatus 10 and is then transported to a kneading device 70 for kneading the solid electrolyte SE, for example. A flow of the solid electrolyte SE is illustrated by the thick arrows in the drawing.

The weighing apparatus 10 is provided in a weighing facility 100, for example. The weighing facility 100 includes, for example, a plurality of levels and specifically includes a first floor part 101, a mezzanine part 101a, a second floor part 102, and a third floor part 103.

The solid electrolyte SE is in the form of powder. The solid electrolyte SE is, for example, a sulfide-based solid electrolyte. However, the type of the solid electrolyte SE is not particularly limited, and the solid electrolyte SE may be, for example, an oxide-based solid electrolyte. The solid electrolyte SE is accommodated in a flexible container 30 (which may be simply referred to as an "FC 30"), for example. A valve 30a that permits or restricts discharge of the solid electrolyte SE, for example, is provided at a lower portion of the FC 30. Note that the FC 30 corresponds to a solid electrolyte transporting container. The solid electrolyte transporting container is freely deformable, for example.

The weighing apparatus 10 includes a glove box 11, a first pipe 12, a first storage-equipped quantitative feeder device 15 (which may be simply referred to as a "first quantitative feeder device 15"), a second pipe 16, a second storage-equipped quantitative feeder device 18 (which may be simply referred to as a "second quantitative feeder device 18"), and a third pipe 19.

The glove box 11 is provided in the third floor part 103, for example. The FC 30 is accommodated inside the glove box 11. The inside of the glove box 11 is adapted such that a dew point can be managed, for example. The glove box 11 can be tightly closed, for example. The inside of the glove box 11 can be purged with nitrogen or air with a managed dew point, for example.

One end of the first pipe 12 is disposed inside the glove box 11. The first pipe 12 extends downward from the glove box 11, for example. The one end of the first pipe 12 can be connected to the valve 30a of the FC 30.

The first quantitative feeder device 15 is provided on the side further downward than the glove box 11, for example. The first quantitative feeder device 15 is provided in the second floor part 102, for example. The first quantitative feeder device 15 includes a first storage 152 that is connected to a first inlet port 151 provided at an upper portion and stores the solid electrolyte SE and a first quantitative feeder 154 that quantitatively measures the solid electrolyte SE stored in the first storage 152 and feeds the solid electrolyte SE to a first outlet port 153 provided in a lower side surface.

The first inlet port 151 is fixed to the other end of the first pipe 12. The first inlet port 151 is disposed in an upper surface of the first quantitative feeder device 15, for example. Note that the first inlet port 151 corresponds to a solid electrolyte inlet port, and the first pipe 12 corresponds to an inlet pipe.

Also, a first dry booth 111 is provided in the second floor part 102. A worker, for example, can work inside the first dry booth 111. An internal space 111a of the first dry booth 111 is a space in which a dew point can be managed. The first dry booth 111 can be tightly closed, for example. The dew point inside the internal space 111a is managed by being purged with air, for example. The first quantitative feeder device 15 is provided inside the first dry booth 111, for example. In other words, the first quantitative feeder device 15 is provided inside a space in which a dew point can be managed.

One end of the second pipe 16 is connected to the first outlet port 153 of the first quantitative feeder device 15. The second pipe 16 extends in the horizontal direction from the first outlet port 153 and further extends downward, for example. Note that the first outlet port 153 corresponds to the solid electrolyte outlet port.

The second quantitative feeder device 18 is provided on the side further downward than the first quantitative feeder device 15, for example. The second quantitative feeder device 18 is provided in the mezzanine part 101a, for example. The second quantitative feeder device 18 includes a second storage 182 that is connected to a second inlet port 181 provided at an upper portion and stores the solid electrolyte SE and a second quantitative feeder 184 that quantitatively measures the solid electrolyte SE stored in the second storage 182 and feeds the solid electrolyte SE to a second outlet port 183 provided in a lower side surface.

The second inlet port 181 is fixed to the other end of the second pipe 16. The second inlet port 181 is disposed in an upper surface of the second quantitative feeder device 18, for example. Note that the second inlet port 181 corresponds to a solid electrolyte inlet port, and the second pipe 16 corresponds to a connection pipe.

Also, a second dry booth 112 is provided in the mezzanine part 101a. A worker, for example, can work inside the second dry booth 112. An internal space 112a of the second dry booth 112 is a space in which a dew point can be managed. The second dry booth 112 can be tightly closed, for example. The dew point inside the internal space 112a is managed by being purged with air, for example. The second quantitative feeder device 18 is provided inside the second dry booth 112, for example. In other words, the second quantitative feeder device 18 is provided inside a space in which a dew point can be managed.

The first pipe 12, the first quantitative feeder device 15, and the second pipe 16 connect the inlet port 13 and the second quantitative feeder device 18. The first pipe 12, the first quantitative feeder device 15, and the second pipe 16 form a flow path for the solid electrolyte SE inside the FC 30 to flow down into the second quantitative feeder device 18.

The third pipe 19 is connected to the second quantitative feeder device 18. The third pipe 19 is connected to the kneading device 70.

The weighing apparatus 10 includes a first air supplier 21, a first exhauster 22, a second air supplier 23, and a second exhauster 24.

The first air supplier 21 is an air supplier that supplies gas to the first quantitative feeder device 15. The first air supplier 21 includes, for example, a piping portion 21a, a compressor 21b, and a gas cylinder 21c. The piping portion 21a is connected to the first storage 152 and the compressor 21b. The compressor 21b is connected to the gas cylinder 21c. The gas cylinder 21c stores gas, and for example, stores nitrogen. The first air supplier 21 supplies the gas inside the gas cylinder 21c to the inside of the first storage 152 through the piping portion 21a in a case where the compressor 21b is turned on, and does not supply the gas inside the gas cylinder 21c to the inside of the first quantitative feeder device 15 in a case where the compressor 21b is turned off, for example.

The first exhauster 22 is an exhauster that exhausts gas from the first storage 152. The first exhauster 22 includes, for example, a piping portion 22a and a compressor 22b. The piping portion 22a is connected to the first storage 152 and the compressor 22b. The first exhauster 22 discharges the gas inside the first storage 152 to the outside of the first quantitative feeder device 15 through the piping portion 22a in a case where the compressor 22b is turned on and does not discharge the gas inside the first storage 152 to the outside of the first quantitative feeder device 15 in a case where the compressor 22b is turned off, for example.

The second air supplier 23 is an air supplier that supplies gas to the second storage 182. The second air supplier 23 includes, for example, a piping portion 23a, a compressor 23b, and a gas cylinder 23c. The piping portion 23a is connected to the second pipe 16 and the compressor 23b. The compressor 23b is connected to the gas cylinder 23c. The gas cylinder 23c stores gas, and for example, stores nitrogen. The second air supplier 23 supplies the gas inside the gas cylinder 23c to the inside of the second storage 182 through the piping portion 23a and the second pipe 16 in a case where the compressor 23b is turned on, and does not supply the gas inside the gas cylinder 23c to the inside of the second storage 182 in a case where the compressor 23b is turned off, for example.

The second exhauster 24 is an exhauster that exhausts gas from the second storage 182. The second exhauster 24 includes, for example, a piping portion 24a and a compressor 24b. The piping portion 24a is connected to the second pipe 16 and the compressor 24b. The second exhauster 24 discharges the gas inside the second storage 182 to the outside of the second pipe 16 through the second pipe 16 and the piping portion 24a in a case where the compressor 24b is turned on, and does not discharge the gas inside the second storage 182 to the outside of the second pipe 16 in a case where the compressor 24b is turned off.

The weighing apparatus 10 includes a controller 50 and an operation unit 60.

The controller 50 is constituted by a microprocessor including a CPU, a RAM, a ROM, an I/O, and the like. The controller 50 includes an adjustment unit 51, a timer 52, a memory unit 53, and a determination unit 54.

The adjustment unit 51 is electrically connected to the first air supplier 21, the first exhauster 22, the second air supplier 23, and the second exhauster 24. The adjustment unit 51 controls the first air supplier 21 and the first exhauster 22 to adjust the pressure inside the first quantitative feeder device 15 (first storage 152). The adjustment unit 51 controls the second air supplier 23 and the second exhauster 24 to adjust the pressure inside the second quantitative feeder device 18 (second storage 182).

The memory unit 53 is implemented by an HDD, a flash memory, a RAM, a ROM, or the like. The memory unit 53 is electrically connected to the first quantitative feeder device 15 and the second quantitative feeder device 18, for example. A weighing result of the first quantitative feeder device 15 and a weighing result of the second quantitative feeder device 18, for example, are input to the memory unit 53. The memory unit 53 stores, for example, the weighing result of the first quantitative feeder device 15 and the weighing result of the second quantitative feeder device 18.

The determination unit 54 is electrically connected to the first quantitative feeder device 15 and the second quantitative feeder device 18, for example. The determination unit 54 executes determination related to the amount of increase in solid electrolyte inside the first quantitative feeder device 15, for example. The weighing result of the first quantitative feeder device 15 and the weighing result of the second quantitative feeder device 18, for example, are input to the determination unit 54. The determination unit 54 is connected to the memory unit 53. The determination unit 54 can read data stored in the memory unit 53.

The determination unit 54 executes determination regarding whether or not an increase in solid electrolyte SE inside the first quantitative feeder device 15 has stagnated, for example. The determination unit 54 determines that "there has been no stagnation" in a case where the amount of increase in weight of the solid electrolyte SE inside the first quantitative feeder device 15 during a predetermined reference period is greater than a predetermined accumulation reference weight, or the determination unit 54 determines that "there has been stagnation" in a case where the amount of increase in weight is equal to or less than the predetermined accumulation reference weight, for example.

The determination unit 54 executes, for example, determination regarding whether or not the increase in solid electrolyte SE inside the first quantitative feeder device 15 has stopped and determination regarding whether or not the increase in the solid electrolyte SE inside the second quantitative feeder device 18, for example. The determination unit 54 determines that "there has been no stopping" in a case where the amount of increase in weight of the solid electrolyte SE inside the first quantitative feeder device 15 within a predetermined reference period is greater than a predetermined stop reference weight, or the determination unit 54 determines that "there has been stopping" in a case where the amount of increase in weight is equal to or less than the predetermined stop reference weight. The predetermined stop reference weight is defined as a value that is smaller than the predetermined accumulation reference weight and is set to zero, for example.

The determination unit 54 executes, for example, determination regarding whether or not an increase in solid electrolyte SE inside the second quantitative feeder device 18 has stagnated and determination regarding whether or not the increase in solid electrolyte SE inside the second quantitative feeder device 18 has stopped. The determination regarding the second quantitative feeder device 18 is executed similarly to the determination regarding the first quantitative feeder device 15, for example. Therefore, description of the determination regarding the second quantitative feeder device 18 will be omitted. Note that various reference values related to the first quantitative feeder device 15 and various reference values related to the second quantitative feeder device 18 may be the same or different.

Also, the adjustment unit 51 controls the first exhauster 22 and the first air supplier 21 to adjust the pressure inside the first quantitative feeder device 15 (first storage 152) and controls the second exhauster 24 and the second air supplier 23 to adjust the pressure inside the second quantitative feeder device 18 (second storage 182) on the basis of the determination results of the determination unit 54, for example.

The operation unit 60 is electrically connected to the controller 50. The operation unit 60 causes the controller 50 to execute predetermined processing on the basis of an operation of a worker. The operation unit 60 is not particularly limited, and may be a personal computer provided in the weighing facility 100, for example, or may be an information terminal carried by the worker.

Next, a weighing method for the solid electrolyte SE using the weighing apparatus 10 will be described.

First, the FC 30 with the solid electrolyte SE placed therein is disposed inside the glove box 11. The valve 30a of the FC 30 with the solid electrolyte SE accommodated therein is connected to the first pipe 12 (connection step). Then, the first dry booth 111 and the second dry booth 112 are purged with air.

Then, the inside of the weighing apparatus 10 is purged with nitrogen. The controller 50 turns on the first air supplier 21 (compressor 21b) and turns on the first exhauster 22 (compressor 22b) on the basis of an operation performed by a worker on the operation unit 60, for example. In this manner, the inside of the first quantitative feeder device 15 is purged with nitrogen.

The controller 50 turns off the first air supplier 21 and turns off the first exhauster 22 once a predetermined time elapses after the start of the purging of the inside of the first quantitative feeder device 15, for example. In this manner, the purging of the inside of the first quantitative feeder device 15 ends. Note that the controller 50 may be configured to end the purging of the inside of the first quantitative feeder device 15 on the basis of an operation performed by the worker on the operation unit 60, for example.

Purging of the inside of the second pipe 16 is executed similarly to the purging of the inside of the first quantitative feeder device 15, for example.

Next, the solid electrolyte SE accommodated in the FC 30 is stored in the first storage 152 of the first quantitative feeder device 15 (storage step). First, the valve 30a of the FC 30 is brought into an open state. The valve is operated from the outside of the glove box 11 by the worker, for example. Once the valve 30a is brought into an open state, the solid electrolyte SE inside the FC 30 drops into the first pipe 12 due to its own weight, for example, and further drops into the first storage 152 through the first inlet port 151.

Then, the solid electrolyte SE inside the first storage 152 is transported to the inside of the second pipe 16 by the first quantitative feeder 154, for example, and further drops into the second storage 182 of the second quantitative feeder device 18 due to its own weight.

Then, the solid electrolyte SE stored in the second storage 182 is quantitatively measured using the second quantitative feeder 184 and is fed to the first outlet port 153 (quantitative measurement step). The solid electrolyte SE is loaded into the kneading device 70 through the third pipe 19.

However, the solid electrolyte SE has a relatively slight tendency to flow. Therefore, there is a concern that the solid electrolyte SE may be accumulated in the first pipe 12 and the second pipe 16, for example.

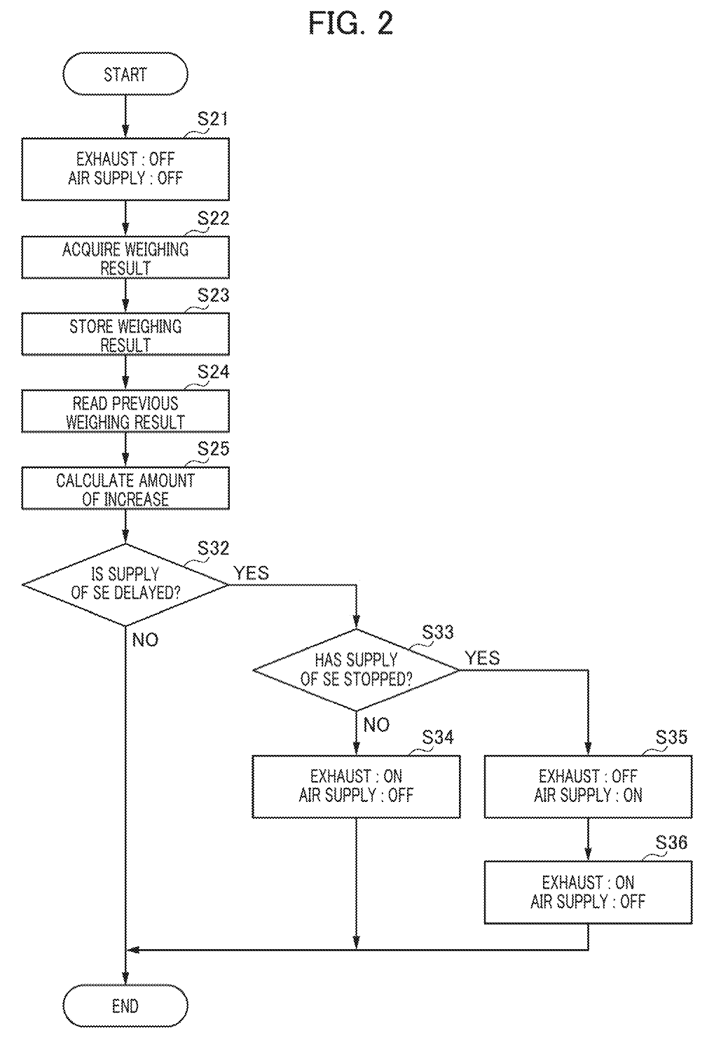

Thus, the controller 50, for example, executes pressure control inside the weighing apparatus 10. Hereinafter, the pressure control performed by the controller 50 will be described with reference to FIG. 2. The processing of a flowchart illustrated in FIG. 2 is repeatedly executed at every predetermined reference period, for example, during driving of the weighing apparatus 10.

Note that control related to the first quantitative feeder device 15 will be described below as an example. Although description will be omitted, control related to the second quantitative feeder device 18 is executed similarly to the control related to the first quantitative feeder device 15, for example.

As illustrated in FIG. 2, the first air supplier 21 is turned off, and the first exhauster 22 is turned off in step S21. Thereafter, the processing proceeds to step S22.

In step S22, the weight of the solid electrolyte SE inside the first storage 152 is acquired from the first quantitative feeder device 15. Thereafter, the processing proceeds to step S23.

In step S23, the weight of the solid electrolyte SE inside the first storage 152 is stored in the memory unit 53. Thereafter, the processing proceeds to step S24. Note that although not illustrated in the drawing, the present processing is ended after step S23 ends in a case where the flowchart of FIG. 2 is executed for the first time.

In step S24, the weight of the solid electrolyte SE inside the first storage 152 stored in the memory unit 53 when the flowchart of FIG. 2 is executed last time is read from the memory unit 53. Thereafter, the processing proceeds to step S25.

In step S25, the amount of increase in weight of the solid electrolyte SE inside the first storage 152 in the predetermined reference period is calculated. For example, a difference between the weight of the solid electrolyte SE inside the first storage 152 newly acquired in step S22 and the weight of the solid electrolyte SE inside the first storage 152 in the past read in step S24 is calculated, and the amount of increase in weight of the solid electrolyte SE inside the first storage 152 in the predetermined reference period is calculated. Thereafter, the processing proceeds to step S32.

In step S32, whether or not the increase in solid electrolyte SE inside the first storage 152 has stagnated is determined. In a case where the amount of increase in weight of the solid electrolyte SE inside the first storage 152 in the predetermined reference period is greater than the predetermined accumulation reference weight, it is determined that there has been no stagnation (NO). Thereafter, the present processing is ended. In a case where the amount of increase in weight of the solid electrolyte SE inside the first storage 152 in the predetermined reference period is equal to or less than the predetermined accumulation reference weight, it is determined that there has been stagnation (YES). Thereafter, the processing proceeds to step S33.

In step S33, whether or not the increase in solid electrolyte SE inside the first storage 152 has stopped is determined. In a case where the amount of increase in weigh of the solid electrolyte SE inside the first storage 152 in the predetermined reference period is greater than the predetermined stop reference weight, it is determined that there has been no stopping (NO). Thereafter, the processing proceeds to step S34. In a case where the amount of increase in weight of the solid electrolyte SE inside the second quantitative feeder device 18 in the predetermined reference period is equal to or less than the predetermined stop reference weight, it is determined that there has been stopping (YES). Thereafter, the processing proceeds to step S35.

In step S34, the solid electrolyte SE accommodated in the FC 30 is suctioned to the inside of the first storage 152 by lowering the inner pressure of the first quantitative feeder device 15 (first storage 152) using the first exhauster 22. More specifically, the first exhauster 22 is turned on, and the first air supplier 21 is turned off. In this manner, the inner pressure of the first storage 152 is lowered, and the inner pressure of the first storage 152 becomes a negative pressure with respect to the inner pressures of the FC 30 and the glove box 11. It is thus possible to suction the solid electrolyte SE from the FC 30 side to the first storage 152 side. Thereafter, the flowchart is ended.

In step S35, the solid electrolyte SE located between the FC 30 and the first storage 152 is pushed out to the inside of the FC 30 by supplying gas to the FC 30 by way of raising the inner pressure of the first quantitative feeder device 15 (first storage 152) using the first air supplier 21. More specifically, the first exhauster 22 is turned off, and the first air supplier 21 is turned on. In this manner, the inner pressure of the first storage 152 is raised, and the inner pressure of the first storage 152 becomes a positive pressure with respect to the inner pressures of the FC 30 and the glove box 11. In that case, it is possible to expand the FC 30 with the pressure of the gas, for example, and to thereby achieve a state where it is easy for the solid electrolyte SE to flow down along the inner surface of the FC 30. Also, it is possible to make it easy to solve clogging of the first pipe 12 by blowing up the solid electrolyte SE inside the first pipe 12 into the FC 30. Moreover, it is possible to enhance flowability of the solid electrolyte SE by moving the solid electrolyte SE inside the FC 30 and the first pipe 12. Thereafter, the processing proceeds to step S36.

In step S36, the solid electrolyte SE accommodated in the FC 30 is suctioned to the inside of the first storage 152 by lowering the inner pressure of the first quantitative feeder device 15 (first storage 152) using the first exhauster 22 similarly to step S34. As described above, the second exhauster 24 is turned on, and the second air supplier 23 is turned off. Since the flowability of the solid electrolyte SE is enhanced in step S35 at this time, the solid electrolyte SE is more easily suctioned from the FC 30 side to the first storage 152 side as compared with the case of step S34. Thereafter, the flowchart is ended. Note that a degree of the negative pressure in step S36 may differ from a degree of the negative pressure in step S34.

Note that the pressure control inside the weighing apparatus 10 described above may be executed by the worker, for example. In that case, the worker himself/herself executes the information acquisition and the calculation corresponding to steps S22 to S25 and the determination corresponding to steps S32 and S33, and operates the operation unit 60 to cause the controller 50 to execute the processing corresponding to steps S21 and S34 to S36, for example.

### Effects of Embodiment

According to the above-described embodiment, the following effects are achieved.

The weighing apparatus 10 according to the above-described embodiment is a weighing apparatus for a solid electrolyte SE for an all-solid-state battery and includes: the first storage-equipped quantitative feeder device 15 including the first storage 152 that is connected to the first inlet port 151 provided at the upper portion and stores the solid electrolyte SE and the first quantitative feeder 154 that quantitatively measures the solid electrolyte SE stored in the first storage 152 and feeds the solid electrolyte SE to the first outlet port 153 provided in the lower side surface; the first pipe 12 that has the one end fixed to the first inlet port 151 and the other end that is connectable to the FC 30 accommodating the solid electrolyte SE; the first exhauster 22 that exhausts gas inside the first storage-equipped quantitative feeder device 15; and the first air supplier 21 that supplies gas to the inside of the first storage-equipped quantitative feeder device 15.

According to such a configuration, the FC 30 and the first storage-equipped quantitative feeder device 15 are connected by the first pipe 12, and it is thus possible to suppress contact of the solid electrolyte SE with air at the time of weighing.

If the FC 30 is disposed inside the glove box 11, there is a concern that the FC 30 may contract due to influences of the pressure of the gas with a progress of the loading of the solid electrolyte SE. If the FC 30 is brought into a contracting state, a state where it is difficult for the solid electrolyte SE to flow down in the FC 30 results, and there is a concern that it may become difficult for the solid electrolyte SE to flow down smoothly from the FC 30 to the first inlet port 151. However, it is possible to suppress accumulation of the solid electrolyte SE by controlling the inner pressure of the weighing apparatus 10 and causing the pressure to act on the solid electrolyte SE according to the weighing apparatus 10 of the above-described embodiment.

Therefore, it is possible to provide the weighing apparatus 10 capable of suppressing contact between the solid electrolyte SE and air and suppressing accumulation of the solid electrolyte SE.

In the weighing apparatus 10 of the above-described embodiment, the first inlet port 151 is disposed in the upper surface of the first storage-equipped quantitative feeder device 15.

With such a configuration, it is possible to suppress degradation of quality of the solid electrolyte SE accommodated in the first storage 152, for example.

The weighing apparatus 10 of the above-described embodiment includes the glove box 11 that accommodates the FC 30.

With such a configuration, it is possible to suppress contact of the solid electrolyte SE with air when the solid electrolyte SE in the FC 30 is loaded into the weighing apparatus 10.

In the weighing apparatus 10 of the above-described embodiment, the first storage-equipped quantitative feeder device 15 and the second quantitative feeder device 18 are disposed in the space in which the dew point is managed.

According to such a configuration, it is possible to suppress degradation of quality of the solid electrolyte SE accommodated in the first storage 152 and the second storage 182, for example.

In the above-described embodiment, the solid electrolyte SE is a sulfide solid electrolyte.

The sulfide-based solid electrolyte, in particular, requires handling in a dry environment among solid electrolytes. With such a configuration, it is possible to smoothy weigh the solid electrolyte SE, which is the sulfide-based solid electrolyte, while suppressing contact thereof with air.

The weighing apparatus 10 of the above-described embodiment further includes the controller 50 that controls the first exhauster 22 and the first air supplier 21 to adjust the inner pressure of the first storage-equipped quantitative feeder device 15.

With such a configuration, it is possible to more suitably suppress accumulation of the solid electrolyte SE.

The weighing apparatus 10 of the above-described embodiment includes the second storage-equipped quantitative feeder device 18 including the second storage 182 that is connected to the second inlet port 181 provided at the upper portion and stores the solid electrolyte SE and the second quantitative feeder 184 that quantitatively measures the solid electrolyte SE stored in the second storage 182 and feeds the solid electrolyte SE to the second outlet port 183 provided in the lower side surface, and the second inlet port 181 of the second storage-equipped quantitative feeder device 18 is connected to the first outlet port 153 of the first storage- equipped quantitative feeder device 15 via the second pipe 16.

With such a configuration, it is possible to adjust the supply speed of the solid electrolyte SE to the second quantitative feeder device 18 by the first quantitative feeder device 15 provided between the FC 30 and the second quantitative feeder device 18.

The weighing method for a solid electrolyte of the above-described embodiment is a weighing method for a solid electrolyte for an all-solid-state battery using the weighing apparatus 10 of the above-described embodiment includes: the connecting the FC 30 accommodating the solid electrolyte SE to the first pipe 12; the storing the solid electrolyte SE accommodated in the FC 30 in the first storage 152 of the first storage-equipped quantitative feeder device 15; and the quantitatively measuring the solid electrolyte SE stored in the first storage 152 using the first quantitative feeder device 15 and the feeding the solid electrolyte SE to the first outlet port 153.

According to such a weighing method, it is possible to suppress contact between the solid electrolyte SE and air until the solid electrolyte SE inside the FC 30 is stored in the first storage 152 and is further weighed. In addition, it is possible to suppress accumulation of the solid electrolyte SE by using the weighing apparatus 10 of the above-described embodiment.

Therefore, it is possible to provide the weighing method capable of suppressing contact between the solid electrolyte SE and air and suppressing accumulation of the solid electrolyte SE.

In the weighing method for a solid electrolyte of the above-described embodiment, the storing includes suctioning the solid electrolyte SE accommodated in the FC 30 to the inside of the weighing apparatus 10 by lowering the inner pressure of the weighing apparatus 10 using the first exhauster 22.

According to such a weighing method, it is possible to cause the solid electrolyte SE inside the FC 30 to smoothly flow down to the first storage 152 and the second storage 182 with the pressure difference of the gas.

In the weighing method of a solid electrolyte of the above-described embodiment, the storing includes pushing the solid electrolyte SE accommodated in the FC 30 out to the inside of the weighing apparatus 10 by supplying gas to the FC 30 by way of raising the inner pressure of the weighing apparatus 10 using the first air supplier 21.

According to such a weighing method, it is possible to expand the FC 30 with the pressure of the gas, for example, and to thereby achieve a state where it is easy for the solid electrolyte SE to flow down along the inner surface of the FC 30. It is thus possible to suitably suppress accumulation of the solid electrolyte SE.

The present invention is not limited to the configuration of the above-described embodiment and can be applied by being appropriately changed without changing the gist of the present invention. Note that combinations of two or more individual desirable configurations described in the above-described embodiment are also encompassed in the present invention.

What is claimed is:

1. A weighing apparatus for a solid electrolyte for an all-solid-state battery, the weighing apparatus comprising:
a first storage-equipped quantitative feeder device including a storage that is connected to a solid electrolyte inlet port provided at an upper portion and stores the solid electrolyte, and a quantitative feeder that quantitatively measures the solid electrolyte stored in the storage and feeds the solid electrolyte to a solid electrolyte outlet port provided in a lower side surface;
an inlet pipe that has one end fixed to the solid electrolyte inlet port and another end connectable to a solid electrolyte transporting container in which the solid electrolyte is accommodated;
an exhauster that exhausts gas from an inside of the first storage-equipped quantitative feeder device; and
an air supplier that supplies gas to the inside of the first storage-equipped quantitative feeder device.

2. The weighing apparatus according to claim 1, wherein the solid electrolyte inlet port is disposed in an upper surface of the first storage-equipped quantitative feeder device.

3. The weighing apparatus according to claim 1, further comprising:
a glove box that accommodates the solid electrolyte transporting container.

4. The weighing apparatus according to claim 1, wherein the first storage-equipped quantitative feeder device is disposed in a space in which a dew point is managed.

5. The weighing apparatus according to claim 1, wherein the solid electrolyte is a sulfide solid electrolyte.

6. The weighing apparatus according to claim 1, further comprising:
a controller that controls the exhauster and the air supplier to adjust a pressure inside the first storage-equipped quantitative feeder device.

7. The weighing apparatus according to claim 1, further comprising:
a second storage-equipped quantitative feeder device including a storage that is connected to a solid electrolyte inlet port provided at an upper portion and stores the solid electrolyte, and a quantitative feeder that quantitatively measures the solid electrolyte stored in the storage and feeds the solid electrolyte to a solid electrolyte outlet port provided in a lower side surface, wherein
the solid electrolyte inlet port of the second storage-equipped quantitative feeder device is connected to the solid electrolyte outlet port of the first storage-equipped quantitative feeder device via a connection pipe.

8. A weighing method for weighing a solid electrolyte for an all-solid-state battery using the weighing apparatus according to claim 1, the method comprising:
connecting the solid electrolyte transporting container accommodating the solid electrolyte to the inlet pipe;
storing the solid electrolyte accommodated in the solid electrolyte transporting container in the storage of the first storage-equipped quantitative feeder; and
quantitatively measuring the solid electrolyte stored in the storage using the first storage-equipped quantitative feeder device and feeding the solid electrolyte to the solid electrolyte outlet port.

9. The weighing method according to claim 8, wherein the storing includes suctioning the solid electrolyte accommodated in the solid electrolyte transporting container to inside of the weighing apparatus by lowering an inner pressure in the weighing apparatus using the exhauster.

10. The weighing method according to claim 8, wherein the storing include pushing the solid electrolyte accommodated in the solid electrolyte transporting container out to inside of the weighing apparatus by supplying gas to the solid electrolyte transporting container by way of raising an inner pressure in the weighing apparatus using the air supplier.
